(19) United States
(12) Patent Application Publication
(10) Pub. No.: US 2009/0297761 A1
(43) Pub. Date: Dec. 3, 2009

(54) FLEXIBLE LAMINATED WOOD MATERIAL AND PROCESS FOR PRODUCING THE SAME

(76) Inventor: Kazutaka Nakayama, Kasukabe-shi (JP)

Correspondence Address: KENYON & KENYON LLP, ONE BROADWAY, NEW YORK, NY, 10004, US

(21) Appl. No.: 12/448,749

(22) PCT Filed: Jan. 16, 2008
(86) PCT No.: PCT/JP2008/050410

§ 371 Date: Jul. 1, 2009

(30) Foreign Application Priority Data
Jan. 19, 2007 (JP) 2007-010038

(51) Int. Cl. B32B 21/13; B32B 38/04; B27D 1/04

(52) U.S. Cl. 428/114; 156/251

(57) ABSTRACT

A flexible laminated wood material produced by applying an adhesive to surfaces of a plurality of wood materials; laminating the plurality of wood materials with their grain directions substantially aligned with each other to obtain a laminated product 2; placing the laminated product 2 in a press machine 7 in a pressure-resistant container 4; compressing the laminated product 2 in a laminating direction to reduce the thickness to ½ to ⅕ of the original thickness in an environment heated with high-pressure steam introduced in the pressure-resistant container 4; cooling the compressed laminated product; and cutting the laminated product along the laminating direction.

### BACKGROUND OF THE INVENTION

1. Field of the Invention

The present invention relates to a process for producing a flexible laminated wood material which is highly elastically deformable.

This application claims priority from Japanese Patent Application No. 2007-010038 filed Jan. 19, 2007, which is incorporated herein by reference in its entirety.

2. Background Art

Examples of laminated wood materials may include lauan plywood, particle boards, medium-density fiberboards (MDF) and oriented strand boards (OSB).

These laminated wood materials may be bent a certain amount if the thickness thereof is 2 mm or less. Thicker wood materials, however, are substantially rigid and thus are very difficult to bend.

Japanese Unexamined Patent Application Publication (JP-A) Nos. 11-77619 and 2005-205799 disclose processes of producing a three-dimensional wood product by softening a wood material in high-pressure steam and then placing the softened wood material into a mold.

These related art processes, however, are devised to permanently keep the deformation of the three-dimensionally processed wood materials, and thus are not devised to elastically restore the deformation.

JP-A-2006-305842 discloses a process of modifying a wood material. The process includes softening the wood material, compressing the wood material to reduce the thickness to ⅔ to ⅓ of the original thickness, and then slightly weakening the pressing force to allow the wood material to expand in thickness to a thickness smaller than the original thickness. The disclosure teaches that the wood material may be given flexibility and elasticity.

This related art process, however, employs large square or round wood materials and does not allow the use of small wood materials such as lumber from thinning, thereby increasing the cost.

### SUMMARY OF THE INVENTION

### Problem to be Solved by the Invention

An object of the invention is to provide a process for producing a flexible laminated wood material which is highly elastically deformable by effectively using small wood materials or wood flakes generated during processing.

### Means to Solve the Problem

In order to solve the problems, a first aspect of the invention is a process for producing a flexible laminated wood material, which includes: applying an adhesive to surfaces of a plurality of wood materials; laminating the plurality of wood materials with their grain directions substantially aligned with each other to obtain a laminated product; compressing the laminated product in a laminating direction to reduce the thickness to ½ to ⅕ of the original thickness in a heated state; cooling the compressed laminated product; and cutting the laminated product along the laminating direction.

Another aspect of the invention is a process for producing the flexible laminated wood material according to the first aspect, in which the temperature the laminated wood material is heated to ranges from 60 to 100° C.

Still another aspect of the invention is a process for producing of the flexible laminated wood material according to the first aspect, in which the temperature the laminated wood material is heated to ranges from not lower than 100° C. to not higher than 140° C.

A further aspect of the invention is a process for producing of the flexible laminated wood material according to the first aspect, in which the adhesive is not cured with heat.

### Effect of the Invention

According to the invention, a flexible laminated wood material that is highly elastically deformable may be obtained by effectively using wood materials that have been otherwise discarded, such as thinned wood.

The temperature the laminated wood material is heated to is preferably 70 to 100° C., which eliminates the need of processing in a pressure-resistant container, thereby simplifying the manufacturing facility and reducing the manufacturing cost.

### BRIEF DESCRIPTION OF THE DRAWINGS

FIG. 1 is a schematic perspective view of an exemplary wood material according to an embodiment of the invention.

FIG. 2 is a schematic perspective view of an exemplary laminated product according to an embodiment of the invention.

FIG. 3 schematically illustrates a configuration of a pressure-resistant container according to an embodiment of the invention.

FIG. 4 is a schematic perspective view of an exemplary laminated product according to an embodiment of the invention.

FIG. 5 is a schematic perspective view of an exemplary flexible laminated wood material obtained in accordance with an embodiment of the invention.

FIG. 6 illustrates a flexible laminated wood material obtained in accordance with an embodiment of the invention shown in a bent position.

FIG. 7 is a graph showing an exemplary stress-strain curve of a flexible laminated wood material obtained in accordance with an embodiment of the invention.

FIG. 8 is a scanning electron micrograph of wood cells of a deformed flexible laminated wood material according to an embodiment of the invention.

FIG. 9 is a scanning electron micrograph of wood cells of a deformed flexible laminated wood material according to an embodiment of the invention.

FIG. 10 is a scanning electron micrograph of wood cells of a wood material.

FIG. 11 is a scanning electron micrograph of wood cells of a consolidated wood material.

FIG. 12 is a graph showing a result of a bending test.

### REFERENCE NUMERALS

1: wood material
2: laminated product
4: pressure-resistant container
7: press machine
11: flexible laminated wood material

### DESCRIPTION OF THE PREFERRED EMBODIMENTS

Referring now to the drawings, an embodiment of the invention will be described in detail.

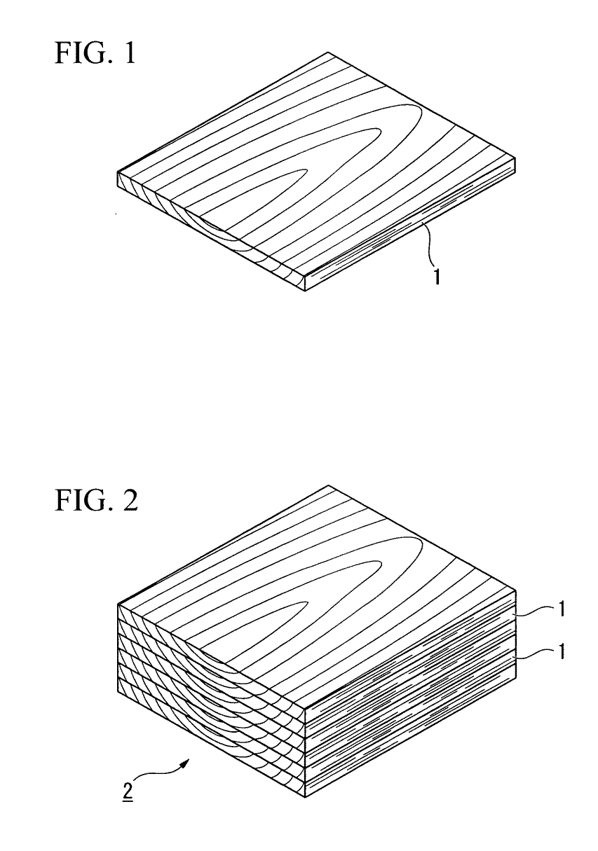

FIGS. 1 to 5 illustrate, in a process sequence, an exemplary process for producing a flexible laminated wood material according to an embodiment of the invention.

A wood material is denoted by the reference numeral 1 in FIG. 1.

The wood material 1 may be a veneer, molded wood flakes or molded wood fibers. The wood material 1 has a thickness of 5 to 30 mm, a width of 10 to 300 mm and a length of 50 to 1000 mm. Various kinds of wood may be used including conifers such as cedar, pine, hemlock, cypress and Hiba cedar. The wood material 1 may preferably include a moisture content of about 5 to 20%.

The wood material 1 is shown as a veneer in the drawings.

An adhesive is applied to a surface of the wood material 1. Examples of the adhesives may include synthetic polymer adhesives, such as a vinyl acetate emulsion adhesive, a phenol resin adhesive, a melamine adhesive, a urea resin adhesive and a polyurethane resin adhesive, tannin adhesives and natural adhesives, such as glue. Among these, adhesives that are not cured in a subsequent heating step, namely, a tannin adhesive and glue are preferred from the viewpoint of not interfering with formation of the wood product in a compressing step.

A plurality of wood materials 1 with the adhesive applied thereon is laminated as shown in FIG. 2. The wood materials 1 are laminated with their grain directions substantially aligned with each other to obtain a laminated product 2.

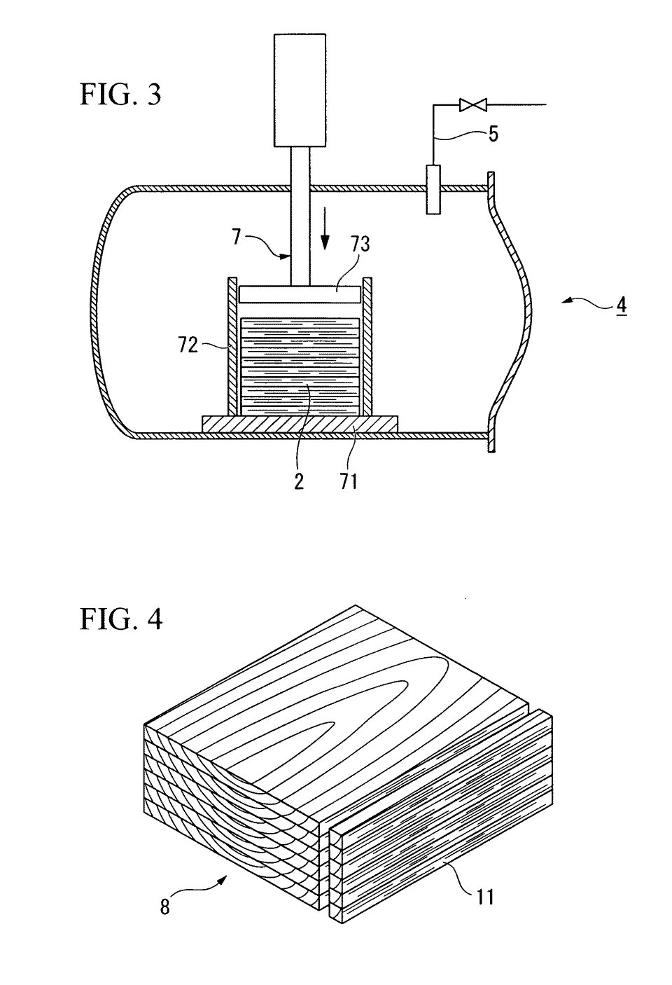

The entire laminated product 2 is then placed in a pressure-resistant container 4 as shown in FIG. 3. The pressure-resistant container 4 includes a press machine 7 therein. The laminated product 2 is placed within a frame 72 on a mounting base 71 of the press machine 7. A pressure plate 73 then presses the laminated product 2 in the vertical direction.

High-pressure steam is introduced into the pressure-resistant container 4 through a pipe 5. The laminated product 2 is heated by the high-pressure steam in an environment with moisture.

The steam treatment is continued for about 0.5 to 5 hours at a steam temperature of 100 to 140° C. The steam treatment softens wood cells of the wood material 1, which makes the wood material 1 highly deformable.

The laminated product 2 is compressed by the press machine 7 in a laminating direction to reduce the thickness to ½ to ⅕ of the original thickness in the pressure-resistant container 4 heated to 100 to 140° C. A heating temperature exceeding 140° C. is not preferred because the flexibility of the wood material 1 may be impaired. The laminated product 2 having a thickness greater than half of the original thickness may have poor elasticity. Excessively large pressing force will be needed to compress the laminated material 2 to a thickness less than ⅕ of the original thickness, which is impractical from an economical viewpoint.

The laminated product 2 is continuously compressed for 0.5 to 2 hours before the heating is halted. After the laminated product 2 is cooled to 50° C. or below, compression is released and the laminated product 2 is taken out of the container 4.

During the heating and compressing processes, the adhesive is cured to provide a block-shaped laminated body 8 with wood plates 1 adhering to one another and the thickness reduced to ½ to ⅕ of the original thickness.

Although the laminated product 2 is heated in the steam atmosphere in the foregoing description, the heating method is not limited thereto. Alternatively, the temperature in the pressure-resistant container 4 may be kept at 60 to 140° C. The pressure plate 72 of the press machine 7 may have a built-in heater to heat the laminated product 2 during compression. The laminated product 2 may be heated by a high frequency heater or may be heated in warm water.

The temperature the laminated wood material is heated to should basically be greater than the softening temperature of the wood material 1. Since the softening temperature falls as the moisture content in the wood material 1 increases, the moisture content of the wood material 1 may preferably be kept at 3 to 5% or higher. Accordingly, the temperature the laminated wood material is heated to is preferably in the range of 60 to 140° C. No pressure-resistant container may be needed if the temperature the laminated wood material is heated to is lower than 100° C. and the laminated product 2 is not heated in a steam environment. Lower temperatures at which the laminated wood material is heated to are preferred because of increased flexibility. Wood cell walls will hardly be softened at a temperature lower than 60° C.

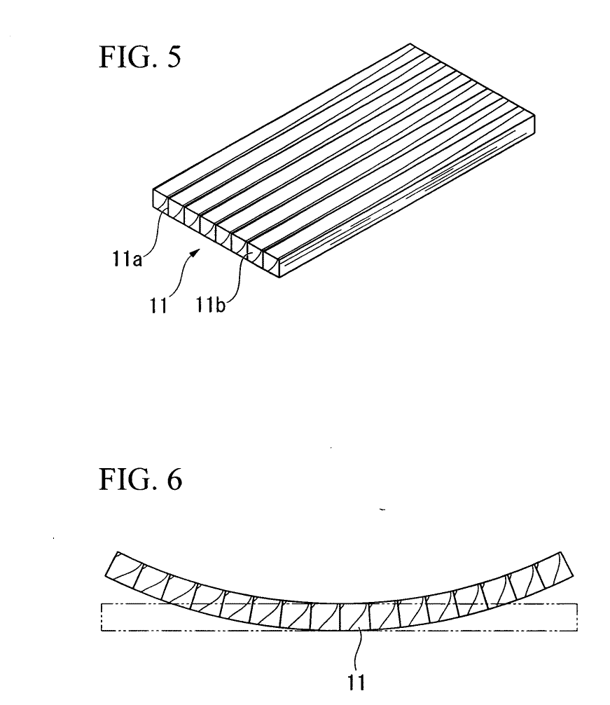

The thus-obtained block-shaped laminated body 8 is then cut into plates along the laminating direction as shown in FIG. 4 with, for example, a saw.

The thus-obtained plate-shaped flexible laminated wood material 11 is shown in FIG. 5. In FIG. 5, laminating surfaces of adjacent wood plates 1 are denoted by the reference numeral 11a and the grains of the wood material 1 are denoted by the reference numeral 11b.

When the flexible laminated wood material 11 receives an external force in the direction of the lamination surface, the flexible laminated wood material 11 is greatly bent as shown in FIG. 6 and restores when the external force is removed. The modulus of elasticity in bending of the flexible laminated wood material 11 is about 1/400 of that of the wood material 1.

In the flexible laminated wood material 11, when the laminated product 2 is heated in an environment with moisture, the wood cell walls of the wood material 1 is softened and the laminated product 2 may be deformed. The laminated product 2 is then compressed and cooled to provide a laminated body 8 with contracted wood cell walls.

Accordingly, the flexible laminated wood material 11 cut out from the laminated body 8 may be extended to the same extent as the wood material 1 before being compressed in the process and may be contracted to the maximum of the deformable range of the wood cell walls.

If the flexible laminated wood material 11 is stretched to fracture along the laminating direction, the stretch ratio at the time of fracture is 40 to 100% and the breaking strength is from 1 to 2.5 N/mm². These values demonstrate that the flexible laminated wood material 11 may be deformed significantly more easily when compared with ordinary wood materials.

Accordingly, the flexible laminated wood material 11 is highly flexible.

If the flexible laminated wood material 11 is once deformed, i.e., stretched, compressed or bent, after it is manufactured, deformation thereafter may be made with smaller external force than that needed for first time deformation.

The flexible laminated wood material 11 is not able to be deformed in all the directions but makes anisotropic deformation. The flexible laminated wood material 11 specifically deforms in a direction perpendicular to the cutting surface thereof, which is the direction along the laminating direction.

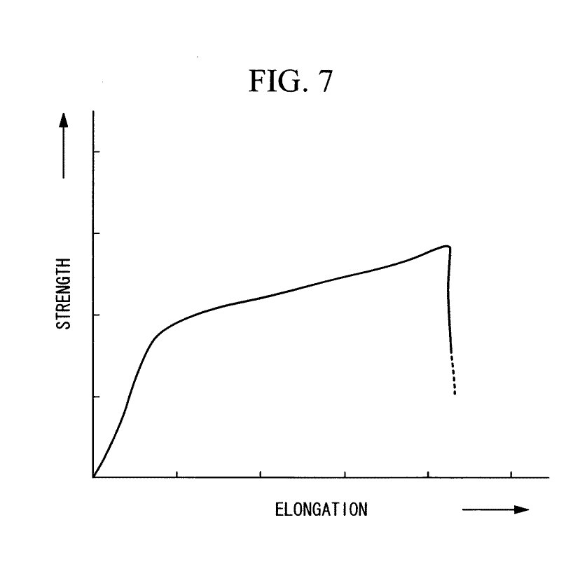

FIG. 7 schematically illustrates an exemplary stress-strain curve showing the result of the tensile test of the flexible laminated wood material 11 according to an embodiment of the invention.

The curve demonstrates that the flexible laminated wood material 11 behaves as an elastic body with higher elastic modulus at an initial stage of deformation and thereafter undergoes plastic deformation with gradually increasing elastic modulus. Thus, the flexible laminated wood material 11 is comparatively hard and resilient.

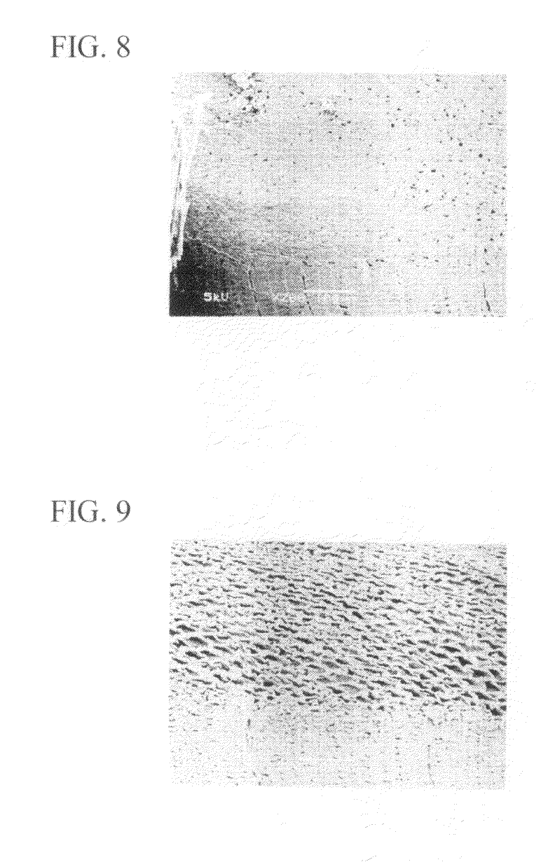

FIGS. 8 and 9 each show scanning electron micrograph of wood cells of a deformed flexible laminated wood material according to an embodiment of the invention. FIG. 8 shows the compressed state and FIG. 9 shows the stretched state.

In its compressed state, the flexible laminated wood material 11 has substantially no gaps, indicating that deformation would hardly occur even if it is under bending stress (i.e., compressed). On the other hand, in its stretched state, the flexible laminated wood material 11 has gaps, indicating that significant deformation recovery would occur and that the flexible laminated wood material 11 may easily be deformed when it is under bending stress (i.e., compressed).

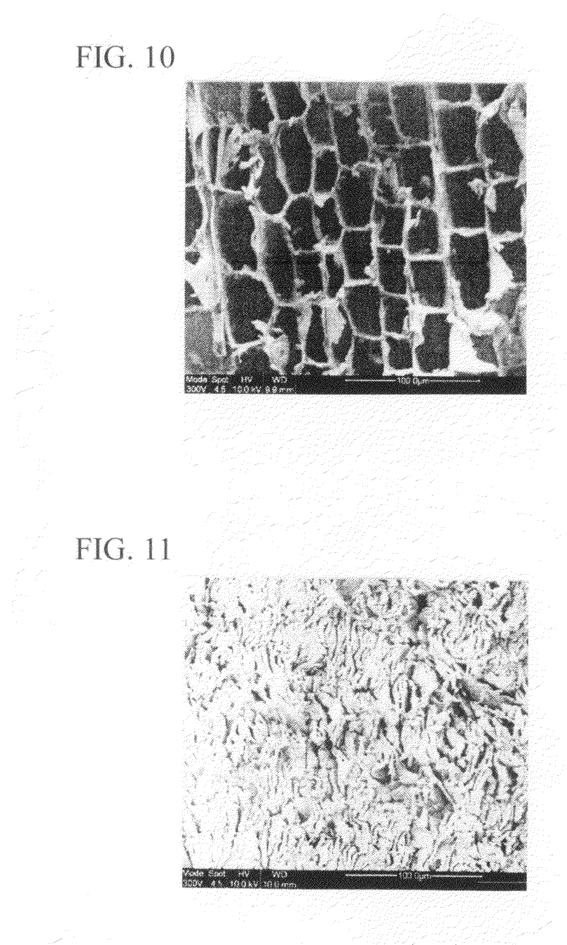

FIG. 10 is a scanning electron micrograph which shows wood cells of a cedar piece as a wood material. FIG. 11 is a scanning electron micrograph which shows wood cells of the cedar piece that has been compressed in an environment with heat. FIG. 11 shows that wood cells are compressed to leave almost no gaps therebetween.

The flexible laminated wood material 11 has various applications. For example, a cylindrical shaped flexible laminated wood material 11 may be used as a wooden pipe. The flexible laminated wood material 11 may also be used as a vibration absorber because of its flexibility. The flexible laminated wood material 11 may also be used as a foundation pile. Since it increases in volume when it absorbs moisture, the flexible laminated wood material 11 may become a friction pile with high frictional force.

Hereinafter, Examples will be described.

### EXAMPLE 1

Twenty-five cedar boards of 20 mm in thickness, 110 mm in width and 500 mm in length are prepared. With a tannin adhesive applied to their surfaces, the cedar boards are laminated with their grain directions substantially aligned with each other to obtain a laminated product. The laminated product is then placed within a frame of a press machine provided in an autoclave.

High-pressure steam is introduced into the autoclave to raise the temperature in the autoclave to 110 to 120° C. After 30 minutes, a press machine is operated to reduce the thickness of the laminated product to 167 mm. The laminated product is kept in this state for one hour before introduction of the high-pressure steam is stopped, and then is cooled to room temperature over 3 hours while still being compressed. In this process, a block-shaped laminated body of 167 mm in thickness, 110 mm in width and 500 mm in length is obtained.

The laminated body is then cut along two surfaces in the laminating direction with a saw to obtain two plate-shaped flexible laminated wood materials. One of them is 5 mm in thickness, 167 mm in width and 500 mm in length. The other is 5 mm in thickness, 167 mm in width and about 105 mm in length.

These flexible laminated wood materials may be easily bent as shown in FIG. 6, and restored to their original states.

### EXAMPLE 2

The flexible laminated wood material obtained in an embodiment of the invention is subject to a bending test.

Three test pieces A, B and C are prepared.

The test piece A is a 20 mm-thick cedar board having a degree of consolidation of 67% prepared by heating at 90° C. for 60 minutes to soften, compressing and then heating at 90° C. for 60 minutes.

The test piece B is a similar cedar board having a degree of consolidation of 53% prepared by heating at 90° C. for 60 minutes to soften, compressing, heating at 90° C. for 30 minutes, slightly weakening the pressing force to reduce the amount of compression and then heating at 120° C. for 30 minutes. The test piece B is prepared according to the process disclosed in JP-A-2006-305842.

The test piece C is a 20 mm-thick cedar board having a degree of consolidation of 67% prepared by heating at 90° C. for 60 minutes to soften, compressing and then heating at 120° C. for 60 minutes.

The test pieces A, B and C all have a thickness of 19 to 20 mm, a width of 19 to 20 mm and a length of 360 to 370 mm.

The bending test is a three-point bending test of the wood material based on JIS Z2101 “methods of testing for woods,” and the span length is set to 280 mm.

Load is given in the middle of the spans of the test piece to measure the amount of deformation at that position. In order to confirm influences of repeated loading, the load is given twice. The first load is given to a test piece which is just cut off. The second load is given to the test piece which is already subject to the first load and is then subject to five sets of manually bending and restoring processes.

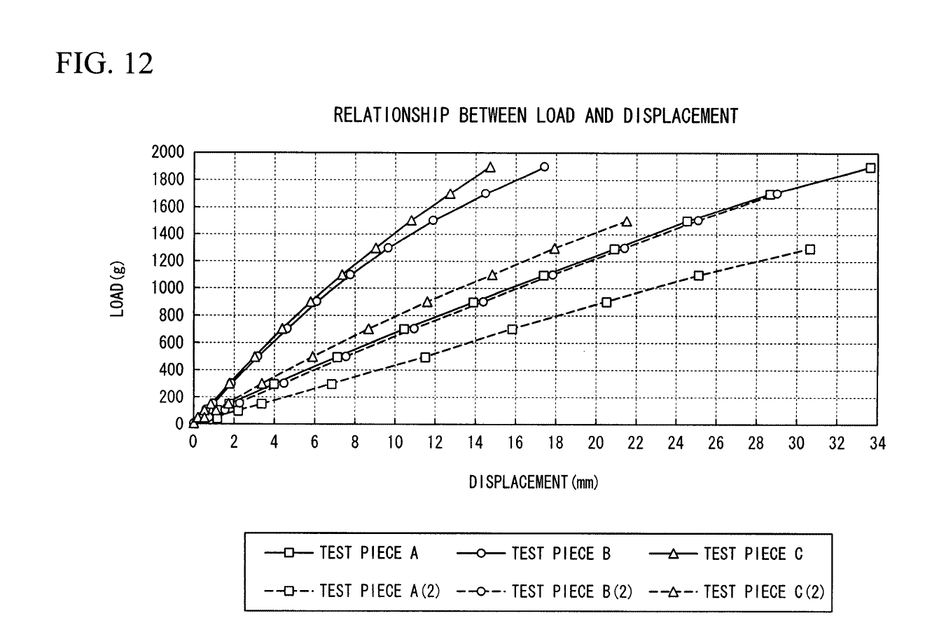

The result is shown in FIG. 12. In FIG. 12 and Table 1, “(2)” represents the second loading.

For the consolidation, test pieces processed at 90° C. is less rigid and thus easy to bend when compared with those processed at 120° C. The bending performance of the test piece B is similar to that of the test piece C.

All the test pieces exhibit lower rigidity for the second loading when compared with the first loading.

The results of the Young's modulus for bending are shown in Table 1. The Young's modulus is measured from the original point. In the proportional part (i.e., the load of 300 g herein), the Young's modulus is 29.2 N/mm², 59.1 N/mm² and 62.4 N/mm² for the test pieces A, B and C respectively for the first loading. In the second loading, the Young's modulus is 16.9 N/mm², 25.0 N/mm² or 31.9 N/mm², respectively, indicating that the test piece A has a Young's modulus about half of that of the test pieces B and C.

Since the Young's modulus for bending of the cedar board is 6860 N/mm², the Young's moduli of the test piece A is about 1/235 for the first loading and is about 1/235 for the second loading, which are extremely small values.

TABLE 1

Young's modulus for bending (N/mm²)

| | Test | Test | Test | Test | Test | Test |
|---|---|---|---|---|---|---|
| | piece | piece | piece | piece | piece | piece |
| Load (g) | A | B | C | A(2) | B(2) | C(2) |
| 48.9 | 40.9 | 55.2 | 93.7 | 16.6 | 23.3 | 35.6 |
| 100 | 33.7 | 58.2 | 71.4 | 17.4 | 23.9 | 33.7 |
| 150 | 32.8 | 57.6 | 65.0 | 17.0 | 24.5 | 32.1 |
| 300 | 29.2 | 59.1 | 62.4 | 16.9 | 25.0 | 31.9 |
| 500 | 27.0 | 58.0 | 60.5 | 16.7 | 24.5 | 31.0 |
| 700 | 25.7 | 56.2 | 58.2 | 17.0 | 23.8 | 29.4 |
| 900 | 24.9 | 54.7 | 56.4 | 16.9 | 23.2 | 28.3 |
| 1100 | 24.3 | 52.5 | 54.4 | 16.8 | 22.9 | 27.0 |
| 1300 | 23.9 | 50.0 | 52.3 | 16.3 | 22.6 | 26.4 |
| 1500 | 23.5 | 46.9 | 50.5 | — | 22.2 | 25.4 |
| 1700 | 22.8 | 43.6 | 48.6 | — | 21.8 | — |
| 1900 | 21.7 | 40.5 | 46.9 | — | — | — |

### INDUSTRIAL APPLICABILITY

According to the invention, a flexible laminated wood material that is highly elastically deformable may be obtained by effectively using wood materials that have been otherwise discarded, such as thinned wood. The invention therefore has significant industrial applicability.

1-4. (canceled)

5. A process for producing a flexible laminated wood material, comprising:
applying an adhesive to surfaces of a plurality of wood materials;
laminating the plurality of wood materials with their grain directions substantially aligned with each other to obtain a laminated product;
heating the laminated product to a temperature of 60 to 140° C.;
compressing the laminated product in a heated state, in a laminating direction to reduce the thickness to ½ to ⅕ of an original thickness;
cooling the compressed laminated product; and
cutting the obtained laminated product along the laminating direction,
wherein the flexible laminated wood material is bendable in a specific direction perpendicular to the laminating direction and is restorable.

6. A flexible laminated wood material obtained in a process comprising:
applying an adhesive to surfaces of a plurality of wood materials;
laminating the plurality of wood materials with their grain directions substantially aligned with each other to obtain a laminated product;
heating the laminated product to a temperature of 60 to 140° C.;
compressing the laminated product in a heated state, in a laminating direction to reduce the thickness to ½ to ⅕ of an original thickness;
cooling the compressed laminated product; and
cutting the obtained laminated product along the laminating direction,
wherein the flexible laminated wood material is bendable in a specific direction perpendicular to the laminating direction and is restorable.

7. A flexible laminated wood material according to claim 6, wherein a stretch ratio at the time of fracture is 40 to 100% when the flexible laminated wood material is stretched along the laminating direction.
